(19) United States
(12) Patent Application Publication
(10) Pub. No.: US 2007/0177706 A1
(43) Pub. Date: Aug. 2, 2007

(54) Hydraulic system for driving control rod drive mechanism

(75) Inventors: Hidekazu Usui, Miura-Gun (JP); Fumihiko Ishibashi, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/341,452

(22) Filed: Jan. 30, 2006

(51) Int. Cl. G21C 7/06

(52) U.S. Cl. 376/219

(57) ABSTRACT

A hydraulic system for driving a control rod drive mechanism includes a control rod drive water pump, a charging line connected to a discharge side of the control rod drive water pump and including a pressure gauge on the discharge side thereof, a purge line connected to the discharge side of the control rod drive water pump for feeding a coolant to a control rod drive mechanism, and a plurality of hydraulic control units connected to the charging line through charging headers and the purge line, each of said hydraulic control units including an accumulator for storing pressurized water using high-pressure gas and a scrum valve through which the accumulator is connected to the control rod drive mechanism. A charging pump is further connected to the charging line so as to independently charge the accumulators with water at a predetermined pressure.

### BACKGROUND OF THE INVENTION

1. Field of the Invention

The present invention relates to a control rod drive hydraulic system for driving a control rod drive mechanism of an advanced boiling water reactor (ABWR) so as to perform emergency insertion of control rods (i.e. scram) by hydraulic pressure, and particularly, to a hydraulic system for driving control rod mechanism (which may be called hereafter “control rod drive hydraulic system”) including a pumping system having an improved configuration serving as a pressurizing source for pressurizing water for driving the control rods.

2. Related Art

The ABWR employs a fine motion control rod drive mechanism (FMCRD: which will simply be referred to as “control rod drive mechanism” hereafter) for controlling insertion/withdrawal of control rods. This enables power (output) control of a reactor and functions thereof such as operation, shutdown, and so forth.

The control rod drive mechanism has two types of drive mechanisms. One is a normal-operation drive mechanism for power control by a driving force of an electric motor. The other one is an emergency drive mechanism for scram which utilizes pressurized water. That is, the control rod drive mechanism has two types of sources of the driving force. One is an electric motor which is used as a power control driving source for normal operation. The other one is a control rod drive hydraulic system (CRD hydraulic drive system) serving as a source of pressurized water for driving the control rods. The control rod drive hydraulic system is made up of an accumulator (HCU accumulator), a control rod drive water pump (CRD pump) and the like, which is used as an emergency drive source for insertion of the control rods in a case of scram.

The control rod drive hydraulic system has a charging line including a pressure gauge provided on the discharge side of the control rod drive water pump. The charging line is connected to multiple hydraulic control units (HCUs) through a charging header. Each hydraulic control unit has an HCU accumulator for storing pressurized water using high-pressure gas. The HCU accumulator is connected to the control rod drive mechanism through a scram valve. In a case of emergency, the HCU accumulator supplies pressurized water to the control rod drive mechanism. This enables scram operation in several seconds or less.

After the scram reset, the HCU accumulator is charged with pressurized water again. Conventionally, high-head and high-pressure control rod drive water pump (control rod drive water pump) is employed as means for charging the HCU accumulator with pressurized water at a necessary predetermined pressure again after the scram reset (for example, refer to Japanese Patent Laid-open (KOKAI) Publication Nos. HEI 8-62366 and HEI 10-31088).

The control rod drive water pump has various functions such as a function for supplying cooling water to the control rod drive mechanism through a CRD purge line (FMCRD cooling water supply function), a function for supplying purge water to a reactor internal pump/reactor water clean-up pump (RIP/CUW) and so on in addition to an HCU accumulator charging function which is a function of charging the HCU accumulator with pressurized water through a charging line. Conventional control rod drive water pumps need to have pump head for each function of the control rod drive mechanism as follows, for example:

About 8 MPa for the FMCRD cooling water supply function;

Approximately 15 MPa for the HCU accumulator charging function; and

Approximately 8 MPa for the RIP/CUW pump purge water supply function.

As described above, the HCU accumulator charging function requires extremely high pump head of approximately 15 MPa for satisfactory operation. Furthermore, the control rod drive water pump needs to operate so as to supply FMCRD cooling water and RIP/CUW pump purge water during the normal (steady) operation. Such functions require an extremely high pump head, high pressurizing, and full-time-operation of the control rod drive water pump. Accordingly, long-time operation of conventional ABWR plants leads to a problem of deterioration in the control rod drive water pump.

Furthermore, a pump with special specifications is employed as such an ABWR control rod drive water pump. Accordingly, the initial cost of the ABWR control rod drive water pump is higher than that of a BWR plant control rod drive water pump. Furthermore, such an ABWR control rod drive water pump requires great electric power, also leading to a problem of high running cost.

Furthermore, with conventional arrangements, the high discharge pressure of the control rod drive water pump causes great difference in pressure at a CRD system flow control valve, flow regulator/orifice of the RIP/CUW pump purge line, control rod drive water pump mini flow line orifice or control rod drive water pump mini flow line manual needle valve, and the like, also leading to a problem of erosion thereof in some cases.

### SUMMARY OF THE INVENTION

Accordingly, an object of the present invention is to substantially eliminate defects or drawbacks encountered in the prior art mentioned above and to provide a hydraulic system for driving a control rod driving mechanism, which aims that a dedicated low-pressure pump for charging an HCU accumulator or a booster pump is used for handling all or a part of the water charging operation of charging the HCU accumulator of the hydraulic control unit with pressurized water for enabling the control rod drive water pump to maintain suitable performance for a long time, as well as relaxing the specifications required thereof such as high pump head.

Another object of the present invention is to provide a hydraulic system for driving a control rod drive mechanism capable of improving reliability, i.e., suppressing deterioration in the control rod drive water pump with advantages of reduced costs, reduced power consumption, and so forth.

A further object of the present invention is to provide a hydraulic system for driving a control rod drive mechanism capable of requiring no full-time operation of the control rod drive water pump at the high discharge pressure so as to suppress erosion occurring at various valves or orifices and charging HCU accumulator with water, which is used for driving the control rods in a sure manner after scram reset.

These and other objects can be achieved according to the present invention by providing, in one aspect, a hydraulic system for driving a control rod drive mechanism comprising:

a control rod drive water pump;

a charging line connected to a discharge side of the control rod drive water pump and including a pressure gauge on the discharge side thereof;

a purge line connected to the discharge side of the control rod drive water pump for feeding a coolant to a control rod drive mechanism;

a plurality of hydraulic control units connected to the charging line through a charging header and the purge line, each of the hydraulic control units including an accumulator for storing pressurized water using high-pressure gas and a scrum valve through which the accumulator is connected to the control rod drive mechanism; and

a charging pump connected to the charging line so as to independently charge the accumulators with water at a predetermined pressure.

In this aspect, the pressure gauge may be disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

The hydraulic system may further include a flow control valve provided downstream of the charging pump, the pressure gauge being disposed on a downstream side of the flow control valve so as to monitor a pressure for charging the water to the accumulator, the flow control valve being operated in a manner such that in a case of detection of a reduction in the pressure, the flow control valve is automatically opened and the charging pump is started so as to charge the accumulator with water at a predetermined pressure, and in a case of detection of a completion of the pressure charging operation, the flow control valve is automatically closed and the charging pump is automatically stopped.

It is desirable that the charging pump is a pump dedicated for a hydraulic control unit accumulator having a pump head of more than 15 MPa.

In another aspect of the present invention, there is also provided a hydraulic system for driving a control rod drive mechanism comprising:

a control rod drive water pump;

a charging line connected to a discharge side of the control rod drive water pump and including a pressure gauge on the discharge side thereof;

a purge line connected to the discharge side of the control rod drive water pump for feeding a coolant to a control rod drive mechanism;

a plurality of hydraulic control units connected to the charging line through a charging header and the purge line, each of the hydraulic control units including an accumulator for storing pressurized water using high-pressure gas and a scrum valve through which the accumulator is connected to the control rod drive mechanism; and

a charging pump incorporated in the charging line so as to charge the accumulators with water at a predetermined pressure in a simultaneous operation with the control rod drive water pump.

In this aspect, it is desirable that the charging line includes a bypass line for bypassing the charging pump.

The pressure gauge may be disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

The hydraulic system may further include a flow control valve disposed on a downstream side of the charging pump.

It is desirable that the charging pump is a booster pump dedicated for a hydraulic control unit accumulator having a pump head of more than 5 MPa.

In a further aspect of the present invention, there is also provided a hydraulic system for driving a control rod drive mechanism comprising:

a control rod drive water pump;

a purge line connected to the discharge side of the control rod drive water pump for feeding a coolant to a control rod drive mechanism;

a charging pump disposed independently of the purge line so as to charge a water at a predetermined pressure;

a charging line connected to a discharge side of the charging pump and including a pressure gauge on a downstream side thereof; and

a plurality of hydraulic control units connected to the charging line through a charging header and the purge line, each of the hydraulic control units including an accumulator for storing pressurized water using high-pressure gas and a scrum valve through which the accumulator is connected to the control rod drive mechanism.

In this aspect, the pressure gauge may be disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

It is desirable that the charging pump is a pump dedicated for a hydraulic control unit accumulator having a pump head of more than 15 MPa.

According to the present invention of the characters mentioned above, an additional pump is disposed for charging the HCU accumulator with water, independent of the control rod drive water pump. Note that a low-pressure dedicated pump or a booster pump is employed as the additional pump. With such an arrangement, the additional pump performs all or a part of the operation or function of charging the HCU accumulator of the hydraulic control unit with water. This enables the performance of the control rod drive water to be maintained for a long time and relaxes the high pump head specifications required thereof. Accordingly, a control rod drive water pump of the kind employed in BWR plants can be employed in the present invention. This improves reliability of the control rod drive water pump, i.e., suppresses deterioration in this pump. Furthermore, this reduces costs and power consumption.

Furthermore, with the system according to the present invention, the control rod drive water pump does not need to operate at the high discharge pressure at all times. This improves the useful life of the control rod drive water pump, as well as reducing costs thereof. Furthermore, the system according to the present invention may include the water lines with reduced maximum pressure specifications, except for the charging line, thereby reducing costs thereof.

In addition, the present invention has the advantages of: relaxation of the pressure-difference conditions for the CRD system flow control valve (conditions for suppressing erosion); relaxation of the pressure-difference conditions for the flow regulator/orifice of the RIP/CUW pump purge line; relaxation of the pressure-difference conditions for the control rod drive water pump mini flow line orifice; relaxation of the pressure-difference conditions for the control rod drive water pump mini flow line manual needle valve (conditions for suppressing erosion); and operation of the control rod drive mechanism with reduced driving force, thereby allowing the costs of the system to be further reduced.

The function of the charging pump for charging the HCU accumulator with water does not require high-speed operation. Accordingly, a small-capacity and high-head pump can be employed with no difficulty. Thus, the system employing such a pump has a sufficient function of charging the HCU accumulator with water for driving the control rods in a sure manner.

The nature and further characteristic features of the present invention will be made clear from the following descriptions made with reference to the accompanying drawings.

### BRIEF DESCRIPTION OF THE DRAWINGS

In the accompanying drawings:

FIG. 1 is a block diagram showing a configuration or structure of a hydraulic system for driving a control rod drive mechanism according to a first embodiment of the present invention;

FIG. 2 is a block diagram showing a configuration or structure of a hydraulic system for driving a control rod drive mechanism according to a second embodiment of the present invention; and

FIG. 3 is a block diagram showing a configuration or structure of a hydraulic system for driving a control rod drive mechanism according to a third embodiment of the present invention.

### DESCRIPTION OF THE PREFERRED EMBODIMENTS

A hydraulic system for driving a control rod drive mechanism according to embodiments of the present invention will be described hereunder with reference to the accompanying drawings. Further, it is to be noted that the hydraulic system for driving the control rod drive mechanism of the present invention may be described hereunder merely as control rod drive hydraulic system for the sake of convenience.

### First Embodiment

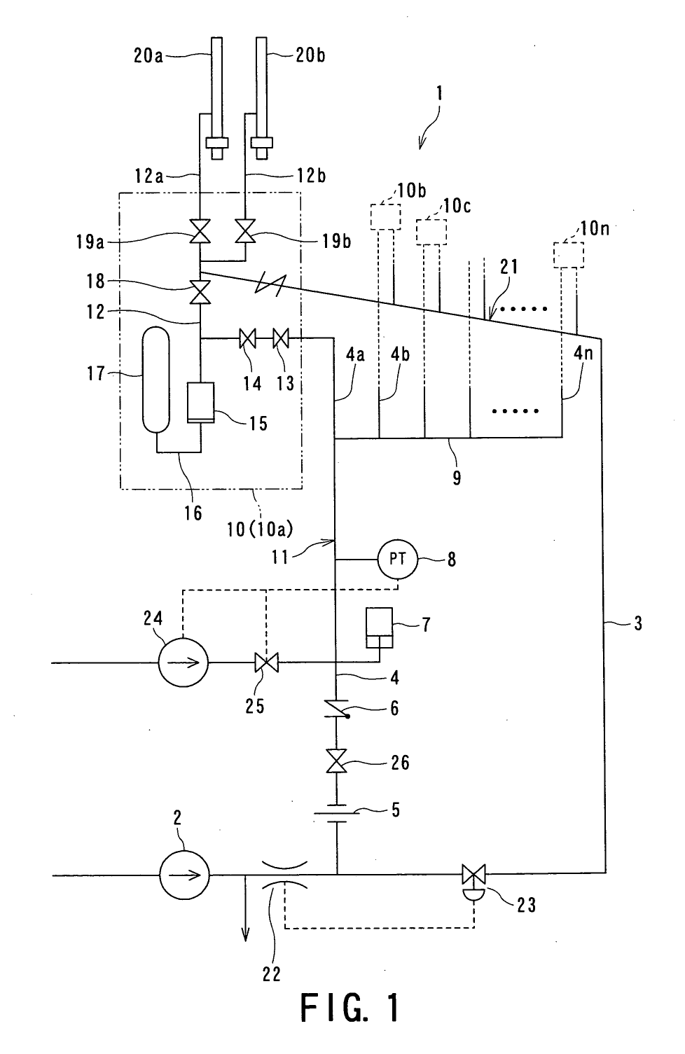

FIG. 1 is a block diagram showing a configuration of a control rod drive hydraulic system according to a first embodiment of the present invention.

Referring to FIG. 1, a control rod drive hydraulic system 1 includes a control rod drive water pump 2 having a discharge port which is branched to a purge water line 3 for supplying cooling water to a control rod drive mechanism and a charging water line 4 for supplying water to an HCU accumulator so as to charge the HCU accumulator with water. The charging water line 4 is connected to a charging header 9 with an orifice 5, a check valve 6, an accumulator 7 and a pressure gauge 8, provided in that order at suitable positions on the way of the line 4.

Multiple charging line branch pipes 4a, 4b, . . . , 4n are connected to the charging header 9. Each of the charging line branch pipes 4a, 4b, . . . , 4n is connected to each of hydraulic control units (HCU) 10 (10a, 10b, ---, 10n) to thereby form a charging line 11.

The hydraulic control unit 10 (10a) includes a drive water line 12 connected to the charging line branch pipes 4a, 4b, . . . , 4n of the charging line 11. The drive water line 12 includes a charging line flow control valve 13 and a charging line check valve 14.

The drive water line 12 includes an HCU accumulator 15. A nitrogen container 17 is connected to the HCU accumulator 15 through a connection line 16.

Furthermore, the drive water line 12 includes a scram valve 18 provided on the downstream side of the HCU accumulator 15. The drive water line 12 is branched to a drive water branch pipes 12a and 12b downstream of the scram valve 18. The drive water branch pipes 12a and 12b are connected to control rod drive mechanisms (CRDs) 20a and 20b through gate valves 19a and 19b.

The purge water line 3 for supplying cooling water to the control rod drive mechanisms 20a and 20b is connected to the scram valve 18 on the downstream side of the drive water lines 12a and 12b, thus forming a CRD purge line 21. Note that a flow meter 22 and a flow control valve 23 serving as a discharge valve are provided to the CRD purge line 21 on the discharge side of the control rod drive water pump 2.

With such an arrangement of the first embodiment of the present embodiment, the pump line 4a is connected to the charging line 11 on the upstream side of the pressure gauge 8. Furthermore, a charging pump 24 is provided to the pump line 4a. It is to be noted that the charging pump 24 has a function for charging the HCU accumulator 15 with water at a necessary predetermined pressure independently without any assistance.

A high-head and small capacity pump such as a plunger pump or the like is employed as the charging pump 24, for example. The charging pump 24 is employed as a dedicated pump for charging the HCU accumulator with water at a pump head of 15 MPa or more.

With such an arrangement, the charging pressure in the HCU accumulator 15 is monitored using the pressure gauge 8 disposed downstream of the charging pump 24. In a case of detecting a reduction of the charging pressure, the charging pump 24 starts to be operated. Upon completion of charging operation, the charging pump 24 is stopped.

Specifically, a flow control valve 25 serving as a discharge valve is provided downstream of the charging pump 24. The pressure gauge 8 is provided downstream of the flow control valve 25 so as to monitor the pressure at which the HCU accumulator 15 is charged with water. In a case of detecting a reduction in the pressure, the flow control valve 25 is automatically opened, and the charging pump 24 is started, thereby charging the HCU accumulator 15 with water at a necessary pressure. On the other hand, upon completion of the charging operation, the flow control valve 25 serving as a discharge valve is automatically closed, and the charging pump 24 is automatically stopped.

Furthermore, the charging water line 4 includes a line switching valve 26 for switching the line between the line of the control rod drive water pump 2 and the line of the charging pump 24. This enables the pump operation mode to be switched between two kinds of single (solo) pump operation modes, i.e., the pump operation using the control rod drive water pump 2 alone and the pump operation using the charging pump 24 alone.

Such a configuration enables selection of the pump operation mode in which the HCU accumulator 15 is charged with water using the charging pump 24 alone without using the control rod drive water pump 2. In this pump operation mode, the HCU accumulator 15 of the hydraulic control unit 10 is charged with water using the charging pump 24 alone, which is a dedicated pump for charging the HCU accumulator with water.

With the present embodiment, after the scram reset, the pump operation mode is switched from the pump operation mode using the control rod drive water pump 2 to the pump operation mode using the charging pump 24 alone, thereby enabling the HCU accumulator 15 to be charged with water at a necessary pressure. This enables the performance of the control rod drive water pump 2 to be maintained for a long time and relaxes the high pump-head specifications required thereof. Accordingly, a control rod drive water pump of the kind employed in conventional, i.e., existing, BWR plant can be employed in the present embodiment. This improves reliability of the control rod drive water pump and suppresses deterioration in this pump. Furthermore, the costs, power consumption, and the like can be reduced effectively.

Furthermore, with the present embodiment, the control rod drive water pump 2 does not need to operate at the maximum pressure specification at all times, so that the useful life of the control rod drive water pump 2 can be improved with reduced costs thereof.

In addition, the present embodiment allows the reduction in the maximum pressure specification of the lines other than the charging line 11, so that the costs for these lines can be reduced. Furthermore, the present embodiment provides the following advantages of: relaxation of the pressure-difference conditions for the CRD system flow control valve (conditions for suppressing erosion); relaxation of the pressure-difference conditions for the flow regulator/orifice of the RIP/CUW pump purge line; relaxation of the pressure-difference conditions for the control rod drive water pump mini flow line orifice; relaxation of the pressure-difference conditions for the control rod drive water pump mini flow line manual needle valve (conditions for suppressing erosion); and operation of the control rod drive mechanism with reduced driving force to thereby allow the costs of the system to be further reduced.

According to the described first embodiment, since the charging pump 24 for charging the HCU accumulator 15 with water does not require the functions of high-speed operation, a small-capacity and high-head pump can be employed as the charging pump 24 with no difficulty. Thus, the system employing such a pump can provide a sufficient function of charging the HCU accumulator 15 with water for driving the control rods in a sure manner.

### Second Embodiment

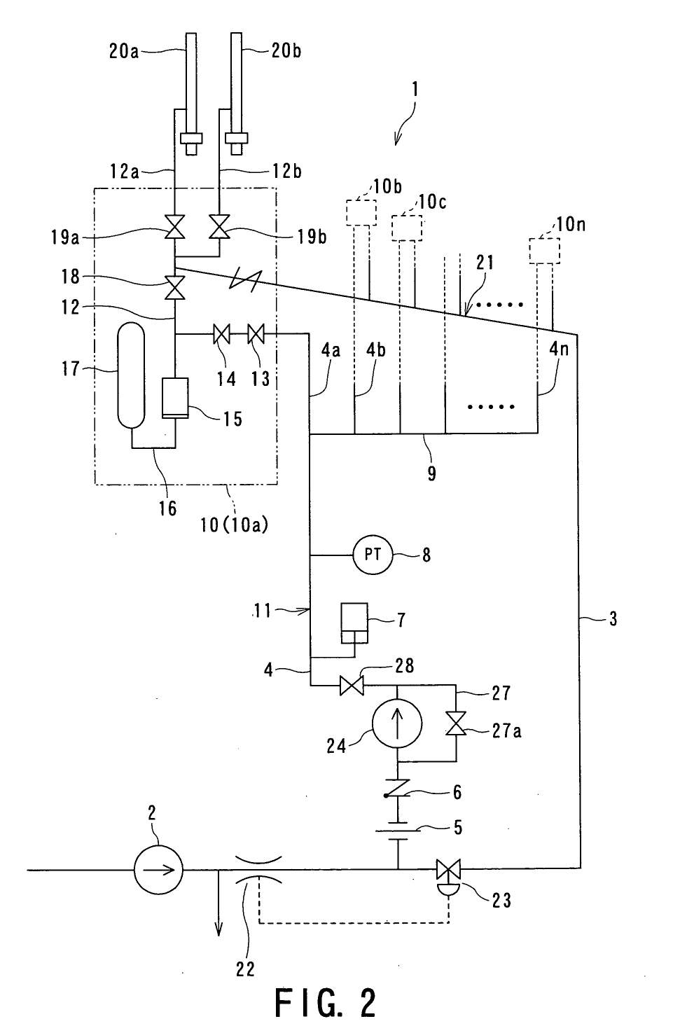

FIG. 2 is a block diagram which shows a configuration of a control rod drive hydraulic system according to a second embodiment of the present invention.

As shown in FIG. 2, the control rod drive hydraulic system 1 according to this embodiment has a configuration, different from that of FIG. 1, in which the charging line 11 includes the charging pump 24. The charging pump 24 operates along with the control rod drive water pump 2, thereby charging the HCU accumulator 15 at a necessary pressure.

That is, the charging pump 24, serving as a booster pump for charging the HCU accumulator, is provided to the charging line 11 in series with the control rod drive water pump 2. The charging pump 24 has pump head of 5 to 7 MPa or more, for example.

Furthermore, the charging line 11 includes a bypass line 27 in parallel with the charging pump 24. With such an arrangement, a bypass valve 27a is opened until the pressure drops to a predetermined value at which the control rod drive water pump 2 alone cannot charge the HCU accumulator 15. That is, the HCU accumulator 15 is charged with water using the control rod drive water pump 2 alone through the bypass line 27 until this point in time.

Accordingly, with the present embodiment, the charging operation is performed using the control rod drive water pump 2 alone until the water-charging pressure drops to a predetermined value, for example, and subsequently, the charging pump 24 operates as an additional booster pump, thereby enabling the charging operation at a necessary pressure in the final stage.

Further, a flow control valve 28 is provided downstream of the charging pump 24 as a discharge valve or drain valve. This prevents the water, with which the HCU accumulator 15 has been charged at a necessary pressure, from flowing backward to the control rod drive water pump 2.

Furthermore, with the system according to this embodiment, the pressure gauge 8 is also provided downstream of the charging pump 24. The pressure at which the HCU accumulator 15 is charged with water is monitored with the pressure gauge 8. The hydraulic system according to the present embodiment has a controlling structure in which in a case of detection of a reduction in the pressure, the charging pump 24 is started. Furthermore, with such a controlling structure, upon completion of the charging operation, the charging pump 24 is stopped.

Specifically, the flow control valve 28 serving as a discharge valve is provided on the downstream side of the charging pump 24. The pressure gauge 8 is also provided on the downstream side of the flow control valve 28 so as to monitor the pressure at which the HCU accumulator 15 is charged with water. In a case of detecting a reduction in the pressure, the flow control valve 28 is automatically opened, and the charging pump 24 is started, so that additional pressurizing is thereby applied to the water with which the HCU accumulator 15 is charged. On the other hand, upon completion of the charging operation, the flow control valve 28 is automatically closed, and the charging pump 24 is automatically stopped.

The other components are generally the same as those of the first embodiment. Accordingly, the corresponding components shown in FIG. 2 are denoted by the same reference numerals as those shown in FIG. 1, and description thereof will be omitted.

With the system according to the second embodiment described above, the control rod drive water pump 2 and the charging pump 22 are started in order after the scram reset, and these two pumps operate in cooperation with each other. Alternatively, these two pumps may be started at the same time. At any rate, either arrangement enables HCU accumulator 15 to be charged with water at a necessary pressure.

With such an arrangement, the charging pump 24 is employed as a dedicated pump for charging the HCU accumulator 15 with water. The charging pump 24 serves as an additional pump for charging the HCU accumulator 15 with water at necessary pressure. Thus, such an arrangement enables the performance of the control rod drive water pump 2 to be maintained for a long time, as well as relaxing the specifications required thereof with respect to the high pump head. Furthermore, a control rod drive water pump of the kind employed in conventional BWR plants can be employed as the control rod drive water pump 2 according to the present embodiment. This improves reliability, i.e., suppresses deterioration in the control rod drive water pump, and reduces costs and power consumption.

In addition, with the present embodiment, the control rod drive water pump 2 does not need to operate at the maximum pressure specification at all times. This improves the useful life of the control rod drive water pump 2, as well as reducing costs thereof.

Furthermore, this second embodiment allows the reduction in the maximum pressure specification of the lines other than the charging line 11. This enables costs for these lines to be reduced. Furthermore, this embodiment has the advantages of: relaxation of the pressure-difference conditions for the CRD system flow control valve (conditions for suppressing erosion); relaxation of the pressure-difference conditions for the flow regulator/orifice of the RIP/CUW pump purge line; relaxation of the pressure-difference conditions for the control rod drive water pump mini flow line orifice; relaxation of the pressure-difference conditions for the control rod drive water pump mini flow line manual needle valve (conditions for suppressing erosion); and operation of the control rod drive mechanism with reduced driving force, thereby allowing the costs of the system to be further reduced.

Further, the charging pump 24 for charging the HCU accumulator 15 with water does not require the function of the high-speed operation. Accordingly, a small-capacity and high-head pump can be employed as the charging pump 24 according to the present invention with no difficulty. Thus, the hydraulic system employing such a pump has a sufficient function of charging the HCU accumulator 15 with water for driving the control rods in a sure manner.

With the present embodiment, the pressure of the charging line is monitored. In a case of detecting a reduction in the pressure, the charging pump serving as an additional pump is started, thereby enabling the water to be pressurized at a predetermined pressure.

### Third Embodiment

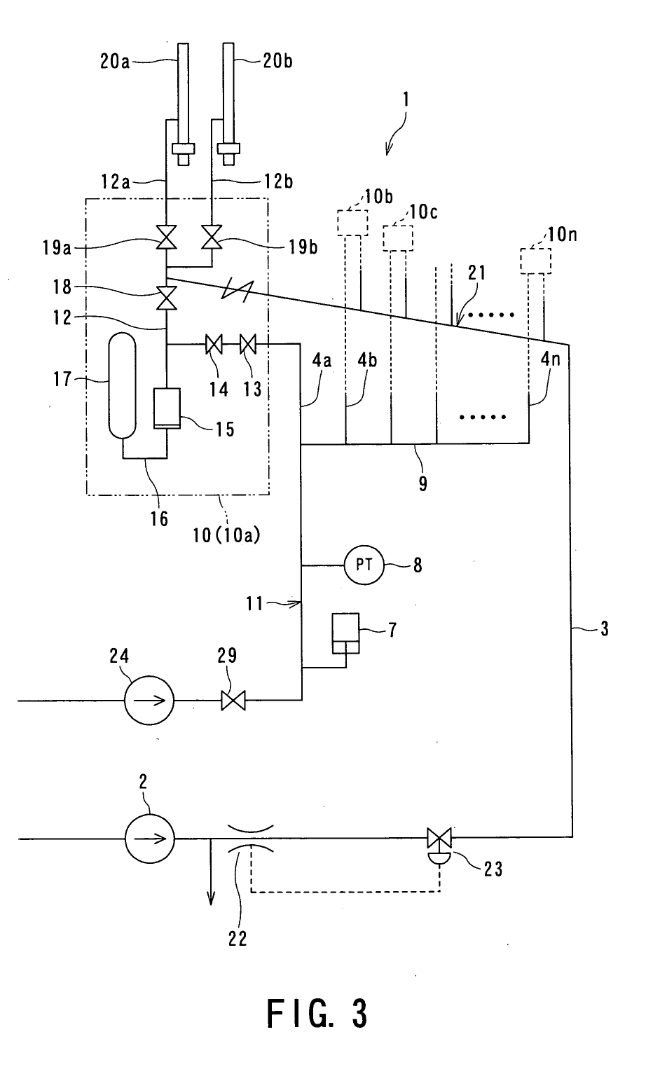

FIG. 3 is a block diagram which shows a configuration of a control rod drive hydraulic system according to a third embodiment of the present invention.

As shown in FIG. 3, the control rod drive hydraulic system 1 includes the cooling water line 21 having the control rod drive water pump 2 and the charging line 11 having the charging pump 24 for scram, independent of each other.

That is, the charging line 11 includes the charging pump 24 having a function of charging the HCU accumulator 15 with water at a necessary pressure independently. The charging line 11, including the charging pump 24, is provided, independent of the cooling water line 21, which has the control rod drive water pump 2.

Furthermore, with regard to the charging line 11 according to this third embodiment, the pressure gauge 8 is also provided downstream of the charging pump 24. The pressure at which the HCU accumulator 15 is charged with water is monitored with the pressure gauge 8. The hydraulic system according to this embodiment has a controlling structure in which in a case of detection of a reduction in the pressure, the charging pump 24 is started. Furthermore, with such a control configuration, upon completion of the charging operation, the charging pump 24 is stopped.

Specifically, a flow control valve 29 serving as a discharge valve is provided downstream of the charging pump 24. The pressure gauge 8 is provided downstream of the flow control valve 29 and monitors the pressure at which the HCU accumulator 15 is charged with water. In a case of detecting a reduction in the pressure, the flow control valve 29 is automatically opened, and the charging pump 24 is started, thereby charging the HCU accumulator 15 with water at a necessary pressure. On the other hand, upon completion of the charging operation, the flow control valve 29 is automatically closed, and the charging pump 24 is automatically stopped.

On the other hand, with the cooling water line 21, purge water is supplied to the control rod drive mechanisms 20a and 20b.

The other components are generally the same as those of the first embodiment. Accordingly, the corresponding components shown in FIG. 3 are denoted by the same reference numerals as those shown in FIG. 1, and description thereof will be omitted.

The hydraulic system according to the third embodiment described above has a function of charging the HCU accumulator 15 with water using the charging pump 24 alone, independent of the control rod drive water pump 2. With such an arrangement, the HCU accumulator 15 of the hydraulic control unit 10 is charged with water using the charging pump 24 alone, which is a dedicated pump for charging the HCU accumulator with water.

Thus, the pump in operation is switched from the control rod drive water pump 2 to the charging pump 24 after the scram reset. Then, the HCU accumulator 15 is charged with water at a necessary pressure using the charging pump 24 alone. Thus, such an arrangement enables the performance of the control rod drive water pump 2 to be maintained for a long time, as well as relaxing the specifications required thereof with respect to high pump head. Furthermore, a control rod drive water pump of the kind employed in conventional BWR plants can be employed as the control rod drive water pump 2 according to the present embodiment. This improves reliability, i.e., suppresses deterioration in the control rod drive water pump, and reduces costs and power consumption.

Furthermore, with the present embodiment, the control rod drive water pump 2 does not need to operate at the maximum pressure specification at all times. This improves the useful life of the control rod drive water pump 2, as well as reducing costs thereof.

In addition, this third embodiment allows the reduction in the maximum pressure specification of the lines other than the charging line 11. This enables the costs for these lines to be reduced. Furthermore, the present embodiment has the advantages of: relaxation of the pressure-difference conditions for the CRD system flow control valve (conditions for suppressing erosion); relaxation of the pressure-difference conditions for the flow regulator/orifice of the RIP/CUW pump purge line; relaxation of the pressure-difference conditions for the control rod drive water pump mini flow line orifice; relaxation of the pressure-difference conditions for the control rod drive water pump mini flow line manual needle valve (conditions for suppressing erosion); and operation of the control rod drive mechanism with reduced driving force, thereby allowing the costs of the system to be further reduced.

Further, the charging pump 24 for charging the HCU accumulator 15 with water does not require the function of high-speed operation. Accordingly, a small-capacity and high-head pump can be employed as the charging pump 24 according to the present invention with no difficulty. Thus, the system employing such a pump has a sufficient function of surely charging the HCU accumulator 15 with water for driving the control rods.

It is further to be noted that the present invention is not limited to the described embodiments and many other changes and modifications may be made without departing from the scopes of the appended claims.

What is claimed is:

1. A hydraulic system for driving a control rod drive mechanism comprising:
a control rod drive water pump;
a charging line connected to a discharge side of the control rod drive water pump and including a pressure gauge on the discharge side thereof;
a purge line connected to the discharge side of the control rod drive water pump for feeding a coolant to a control rod drive mechanism;
a plurality of hydraulic control units connected to the charging line through a charging header and the purge line, each of said hydraulic control units including an accumulator for storing pressurized water using high-pressure gas and a scrum valve through which the accumulator is connected to the control rod drive mechanism; and
a charging pump connected to the charging line so as to independently charge the accumulators with water at a predetermined pressure.

2. The hydraulic system for driving a control rod drive mechanism according to claim 1, wherein said pressure gauge is disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

3. The hydraulic system for driving a control rod drive mechanism according to claim 1, further including a flow control valve provided downstream of the charging pump, said pressure gauge being disposed on a downstream side of the flow control valve so as to monitor a pressure for charging the water to the accumulator, said flow control valve being operated in a manner such that in a case of detection of a reduction in the pressure, the flow control valve is automatically opened and the charging pump is started so as to charge the accumulator with water at a predetermined pressure, and in a case of detection of a completion of the pressure charging operation, the flow control valve is automatically closed and the charging pump is automatically stopped.

4. The hydraulic system for driving a control rod drive mechanism according to claim 1, wherein said charging pump is a pump dedicated for a hydraulic control unit accumulator having a pump head of more than 15 MPa.

5. A hydraulic system for driving a control rod drive mechanism comprising:
a control rod drive water pump;
a charging line connected to a discharge side of the control rod drive water pump and including a pressure gauge on the discharge side thereof;
a purge line connected to the discharge side of the control rod drive water pump for feeding a coolant to a control rod drive mechanism;
a plurality of hydraulic control units connected to the charging line through a charging header and the purge line, each of said hydraulic control units including an accumulator for storing pressurized water using high-pressure gas and a scrum valve through which the accumulator is connected to the control rod drive mechanism; and
a charging pump incorporated in the charging line so as to charge the accumulators with water at a predetermined pressure in a simultaneous operation with the control rod drive water pump.

6. The hydraulic system for driving a control rod drive mechanism according to claim 5, wherein said charging line includes a bypass line for bypassing the charging pump.

7. The hydraulic system for driving a control rod drive mechanism according to claim 5, wherein said pressure gauge is disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

8. The hydraulic system for driving a control rod drive mechanism according to claim 5, further comprising a flow control valve disposed on a downstream side of the charging pump.

9. The hydraulic system for driving a control rod drive mechanism according to claim 5, wherein said charging pump is a booster pump dedicated for a hydraulic control unit accumulator having a pump head of more than 5 MPa.

10. A hydraulic system for driving a control rod drive mechanism comprising:
a control rod drive water pump;
a purge line connected to the discharge side of the control rod drive water pump for feeding a coolant to a control rod drive mechanism;
a charging pump disposed independently of the purge line so as to charge a water at a predetermined pressure;
a charging line connected to a discharge side of the charging pump and including a pressure gauge on a downstream side thereof; and
a plurality of hydraulic control units connected to the charging line through a charging header and the purge line, each of said hydraulic control units including an accumulator for storing pressurized water using high-pressure gas and a scrum valve through which the accumulator is connected to the control rod drive mechanism.

11. The hydraulic system for driving a control rod drive mechanism according to claim 10, wherein said pressure gauge is disposed on a downstream side of the charging pump so as to monitor a pressure for accumulating the water in a manner such that in a case of detection of a reduction in the pressure, the charging pump is started and in a case of detection of a completion of the charging operation, the charging pump is stopped.

12. The hydraulic system for driving a control rod drive mechanism according to claim 10, wherein said charging pump is a pump dedicated for a hydraulic control unit accumulator having a pump head of more than 15 MPa.
